(19) United States
(12) Patent Application Publication
(10) Pub. No.: US 2025/0094939 A1
(43) Pub. Date: Mar. 20, 2025

(54) WASTE ATTRIBUTION SYSTEM

(71) Applicant: NADEERA TECHNOLOGIES LTD, Abu Dhabi (AE)

(72) Inventors: Mohamad Rabih EL CHAAR, Abu Dhabi (AE); Reem KHATTAR, Abu Dhabi (AE); Michel MOKBEL, Abu Dhabi (AE); Ray EL HAYEK, Abu Dhabi (AE)

(21) Appl. No.: 18/699,749

(22) PCT Filed: Jun. 8, 2022
(86) PCT No.: PCT/IB2022/055337

§ 371 Date: Apr. 9, 2024

(51) Int. Cl. G06Q 10/30

(52) U.S. Cl. CPC G06Q 10/30

(57) ABSTRACT

The invention relates to the technical field of waste management, and particularly discloses a system comprising a method and devices to identify waste generation source, open waste container, inspect waste to assess the quality of the User waste sorting and allocation, and provide feedback and incentives/disincentives to improve the future quality of waste sorting. The system comprises tagged waste containers, a User Handheld Interface device, a collection point, a sorting process, a Collection Officer handheld device, a Technician handheld device and a rating process. Waste management authorities receive data analytics on User sorting performance, overall key performance indicators relating to quality of waste sorting, and recommendations of any actions needed to improve individuals or overall waste sorting of Users.

### TECHNICAL FIELD

The invention relates to the technical field of automated sorted waste classification and auditing. In particular, the current invention allows municipal waste attribution, categorization, decision making, and personalized educational feedback.

### BACKGROUND

Sorting waste is defined as an activity to separate generated waste at source according to material type and in line with current practices/legislations. At present residents are not segregating their wastes at the household level and are disposing their refuse in a mixed fashion which is negatively impacting the viability of contemporary waste recovery schemes and is resulting in low rates of recyclables recovery. In the absence of source segregation, a linear disposal-based system that relies on environmentally taxing, end of the pipe solutions such as waste-to-energy or landfilling prevail. The principles of the hierarchy of waste management explicitly state that following prevention and reduction, the most preferred option for the management of generated refuse is recycling, with disposal being the least. However, in the absence of source segregation the process of recycling wastes becomes exceedingly inefficient and expensive, as the value of the recovered wastes dramatically decreases because of high levels of cross-contamination and the process of segregating said waste becomes more expensive. Segregating wastes at source reduces the operational costs involved in recovering recyclables, improves the quality of the recovered material, and increases the proportion of the waste stream that is recovered. Sorting at source involves segregating wastes at the household level into different bags or containers depending on their composition. The recoverable recyclable portion of the segregated wastes would go on to be subject to secondary and tertiary sorting at material recovery and recycling facilities. Meanwhile, the remainder of the waste stream, which would predominantly be composed of organic material and rejects, would either be treated and/or disposed of.

However, should source segregation programs exist, their efficacy would be contingent on resident and user knowledge and compliance, which are often at sub-optimal levels and constantly fluctuate. In the absence of user traceability and feedback mechanisms, ascertaining and maintaining high levels of compliance with established sorting programs would be challenging. Poorly sorted wastes would impact the bottom-line of the entity charged with managing the wastes of a target area, given that, as mentioned above, contaminated waste streams demand higher operational and investment costs to handle, resulting in low recovery rates, and poor-quality recyclables. Accordingly, a traceability mechanism that can educate those who are misinformed or completely uneducated on the subject and hold violators accountable for it, can now yield numerous social, environmental, and economic dividends as extended producer responsibility becomes feasible.

Furthermore, when items are wrongly allocated, the contaminated waste streams increase the likelihood of occupational hazards, which in turn reduces the productivity of workers, the breakdown of equipment, and increases disposal rates.

Throughout the years, private and public bodies have approached sorting at source from different angles in an attempt to “purify” dedicated wastes streams to the utmost extent, though with equivocal results. One novel system is to label the waste containers in a way that allows authorities to trace such containers back to the corresponding user, however, the tracking process is done manually and requires a lot of manpower and time. Furthermore, very few are the systems that give the opportunity to send feedback, warning or even recognition to the user. And lastly, while privacy is key, none of the systems maintain the anonymity of the user.

In what is considered the closest prior art, CN111731702A discloses a municipal waste classification treatment supervision system, which comprises a user side, a server, and a waste classification monitoring server. While this invention allows the waste sorting assessment at the source as much as at the authorities' level, it does not give a detailed report to the authorities' management concerning the sorting performance, nor a recommendation concerning how to improve it.

Another document that could be considered as one of the closest prior art documents is document number WO2019010935A1 which discloses a garbage classification recycling system. The garbage classification recycling system comprises a two-dimensional code label, a garbage recycling bin, a garbage transfer station, and a garbage disposal station. While this system allows tracking of the waste bags back to the original user, it only monitors the bags' weight, and allocates points by the special garbage recycling bin to the user in case sorting was done properly.

Document CN110223210A discloses a kind of waste management system for tracking, including refuse bag, dustbin, and server end. Although this system presents the opportunity to track the waste bag, it does not respect the anonymity of the user.

Document CN102000688B provides a household garbage separate collection system. The system comprises an A-type garbage bag, a B-type garbage bag with unique identification codes, and an outdoor sorted garbage can. While this system allows the assessment of the sorting, it does not provide feedback to the authorities or the users, nor does it respect the anonymity of the latter.

In brief, none of the prior art or existing systems fully address a number of defaults that the present invention solves. There is still the need to improve, optimize and accelerate the process of waste attribution. The present invention proposes further solutions for filling these gaps and executing on these tasks by disclosing an inventive process.

### BRIEF SUMMARY OF THE INVENTION

The embodiment of the invention provides a municipal waste classification supervisory and reward system for attributing waste to households while maintaining the anonymity and privacy of the households and rewarding sorters for doing so, solving the problem of low sorting quality, the absence of incentive schemes, and the lack of feedback to the authorities and the Users in the prior art.

The invention comprises:
a unique and anonymous tag on a waste container (visual tags such as QR code or electronic tag such as RFID) to identify the type of waste and unique account identifier to the household;
a user device (standalone or mobile) that allows a user to associate tags to their accounts and allow them to self-check their sorting quality prior to disposing a bag. Also, this device allows said User to receive feedback, education, and notification of incentives/disincentives reflecting the quality of waste sorting achieved;
a collection point;
a technician device (standalone or mobile) that comprises the following steps:
   identifying the type of waste that the container is ought to have and confirming the said User account validity via visual and/or audio signal;
   a manual, semi-automated or fully automated opening of the waste container to make its content visible for inspection;
   inspection of the container for its content by using Artificial Intelligence or by manual means to verify that it is in-line with set directions;
   recording a score reflecting the quality of sorted waste;
   registration of the inspection feedback;
   sending feedback to Users, specific educational content, and notification of incentives/disincentives based on the sorted waste quality.

### BRIEF DESCRIPTION OF THE DRAWINGS

FIG. 1 “Onboarding”. This phase comprises “Municipality or Community management” and “User” registration. The term “Municipality” includes actual municipalities, communities, and residential compounds.

FIG. 2 “Onboarding Phase”. This phase comprises the activation of linked identifiers/visual tags to households/User accounts and the dissemination of instructional and marketing materials.

FIG. 3 “Waste Disposal/Pickup Requests” at the household level. This phase covers waste disposal and container tagging, that take place at the household/commercial entity by the Resident or User.

FIG. 4 “Collection”. This phase covers the waste collection process conducted by Collection Officers from households/commercial entities.

FIG. 5 “Waste Container Inspection by the Collectors”. This phase covers the preliminary inspection conducted by Collection Officers to ensure that the waste containers are up to the standards.

FIG. 6 “Waste Inspection by Technicians”. This phase covers the waste container inspection process that is done at the Material Recovery Facility by the Technician using the Inspector Module.

FIG. 7 “Technicians' Feedback”. This phase covers the process of issuing the feedback report by the Technicians.

FIG. 8 “Inspection by Officials and HQ”. This phase covers the data compilation and analysis operations conducted at the level of the municipality and HQ. This phase also covers issuing rewards and penalties to the Users, and returning feedback to the latter.

FIG. 9 Automated inspection and rating system.

### GLOSSARY

HQ Admin: has access to all data compiled on the Database and is responsible for all operations and overviews the whole process

Official: This persona, can be a Municipality or Community or Property Management official representative, and is responsible for overseeing any of the aforementioned's operations, and approving and issuing recognition and penalties to Users. The assigned Official is the only persona that has access to any personal data linked to Users and is bound by strict written confidentiality obligations.

User: This persona could be a member of a household or the manager of a commercial entity and is responsible for tagged waste containers disposal and interacting with the User Handheld Interface or Offline operations.

Collection Officer: This persona is responsible for waste collection such as from households or commercial entities in the target area of operation, in addition to being in charge of scanning collected containers using the Collector handheld interface.

Technician: is the head of operations at the target area. This person conducts and oversees the inspection process at the Material Recovery Facility, and is responsible for examining and rating waste containers, and reporting data back to HQ Admin. This Technician can either personally conduct the inspection through a semi-automated process using Technician handheld User Interface device or operate a fully automated system for inspection.

User Handheld Interface: is an interface on a standalone device or mobile that permits the User to track the collection schedules, request special pickups, check collection points, reminders, feedback, reward points, . . .

Collection Officer Handheld Interface: interface on a standalone device or mobile that permits the Collection Officer to check the pickup schedules, send basic data to the server, check the validity of the waste containers tags, . . .

Technician Handheld Interface: interface on a standalone device or mobile that permits the Technician to inspect and rate waste containers along with submitting feedbacks and reports.

Material Recovery Facility: a facility where all the waste containers are assembled in order to undergo the sorting and rating process.

### DETAILED DESCRIPTION OF THE INVENTION

The technical solutions of the present invention are described in detail below with reference to the accompanying drawings and specific embodiments. It should be understood that the specific technical features of the embodiments and the embodiments of the present invention are only illustrative of the technical solutions of the invention and are not limited. The specific technical features in the embodiments of the present invention and the embodiments may be combined with each other.

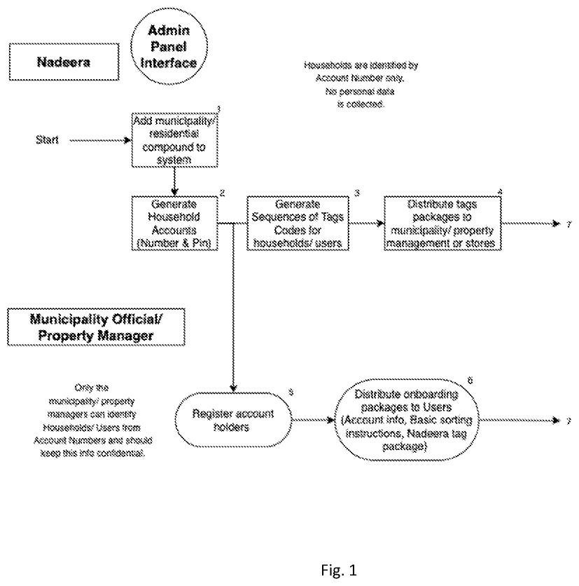

FIG. 1 shows the first step of the process of the system. Said step comprises creating an account by the HQ Admin for each new target area. The account is fully accessible by HQ Admin. The first step further comprises HQ Admin creating a defined number of User accounts and PIN codes. Said User accounts are distributed or assigned to each User/household.

In one embodiment, the Municipality account created by HQ Admin is partially or fully accessible by assigned Official.

In another embodiment, all personal data related to the Users are only known and accessible by the assigned Official.

As shown in FIG. 1, the Official distributes to each User/household an onboarding package comprising account information card, sorting instructions flyer, Identifier sequence, activation instructions flyer and complementary tagged waste containers.

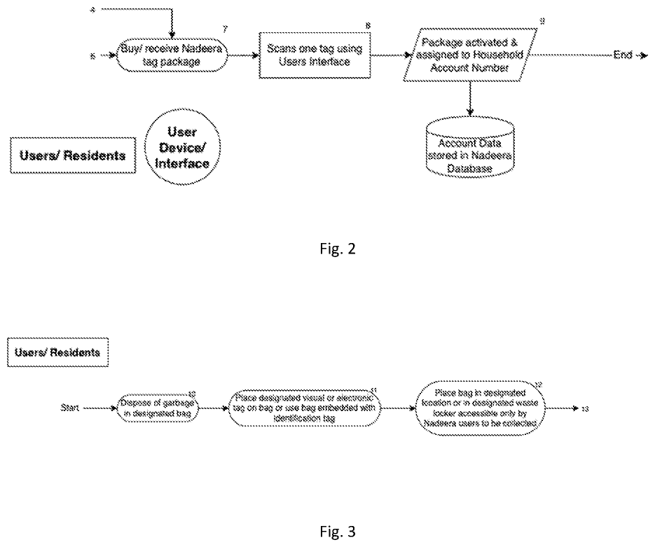

In one embodiment, as shown in FIG. 2, the tagged waste container package comprises a series of tagged containers wherein the User uses the “Activate Identifier series” feature on the User Handheld Interface to scan any Identifier tag from the tag package to link it to their profile. Scanning only one tag of the package is enough to link the series of tags present in said package to the User's profile. This feature is time efficient since by scanning only one tag of the package, all the series of tags in the package are linked to a specific User.

In one embodiment, Users would get a package of tags that can be placed on waste containers.

In a preferred embodiment, the tagged containers are distributed or sold to Users.

In another embodiment, the tagged containers are available in regular stores for the Users to buy/get.

In a preferred embodiment, the tagged containers are QR code tags.

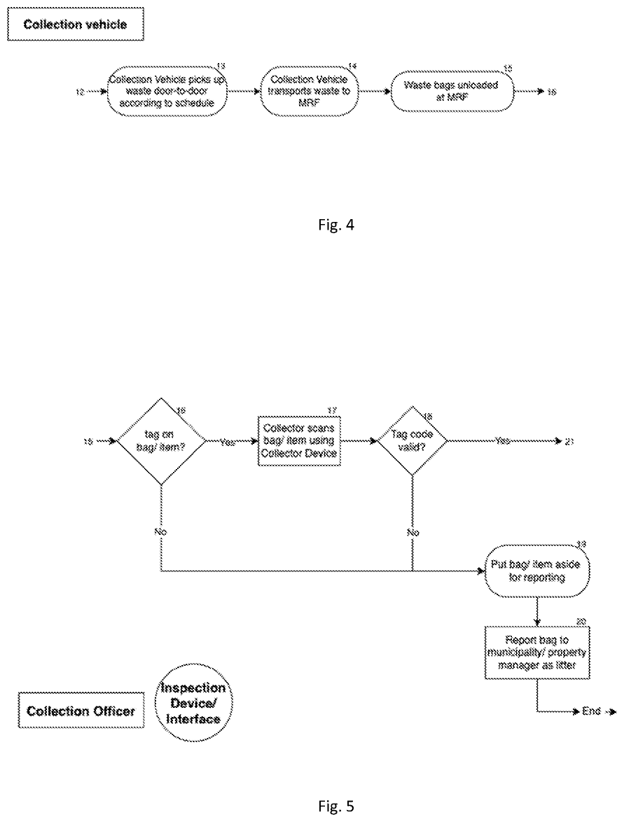

As shown in FIG. 4, Users conduct an initial triage process by disposing the waste in allocated containers (For example: Residuals, Organics, Recyclables and Special Waste). Each container should have a tag on them.

In one embodiment, the User Handheld Interface comprises a camera wherein the User aims the camera at the waste, the camera is then used for collecting image information of the waste thrown into the waste collecting container; the waste classification recognition module present in the servers at HQ is used for analyzing the image information to obtain waste classification result information, judging whether the waste classification result is correct or not, if not, generating alarm information and sending the alarm information to the User. By using this feature, the mistakes during sorting are reduced and as a result, the waste contamination decreases.

In one embodiment, the residual and organic waste containers are picked up according to a schedule on the User platform from specific pickup points at the collection points.

In a preferred embodiment, the recyclables and special waste are dropped off by Users at smart collection points for pick up.

In the same preferred embodiment, the smart collection points will be only accessible to users with labeled containers or through the User's account or device. The collection points will open after the User gains access in order for said User to deposit the tagged waste containers.

In the same preferred embodiment, a sensor embedded in the smart collection point will detect when the smart collection is approaching its holding capacity. A signal is then sent to the HQ signaling the need for pick up.

In one embodiment, a waste collection vehicle follows a collection schedule wherein Collection Officers pick up waste containers in order to deliver them to Material Recovery Facility assigned for the target area.

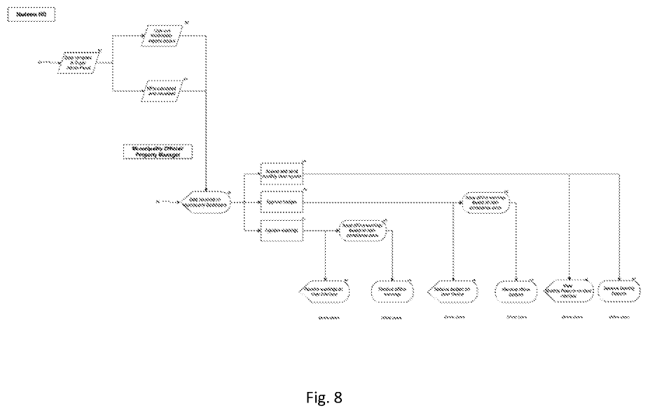

At that point, as shown in FIG. 5, a preliminary inspection of the waste containers is conducted by the Collection Officers or through an automated machine and the Collection Officer Handheld Interface to check if the waste container tag is valid. The Collection Officers would scan the waste container tag using the Collector Module on the Collector handheld interface. This is done to register the container on system and ensure the Identifier is valid. If the tag is missing from waste container and/or the scanned Identifier and the serial code accompanying it are not valid, the Collection Officer puts the container aside for investigation and reporting. The system issues a report on the untagged container/invalid Identifier code to the municipality as shown in FIG. 8 and the container is sent to a conveyor belt for the non-valid containers 902.

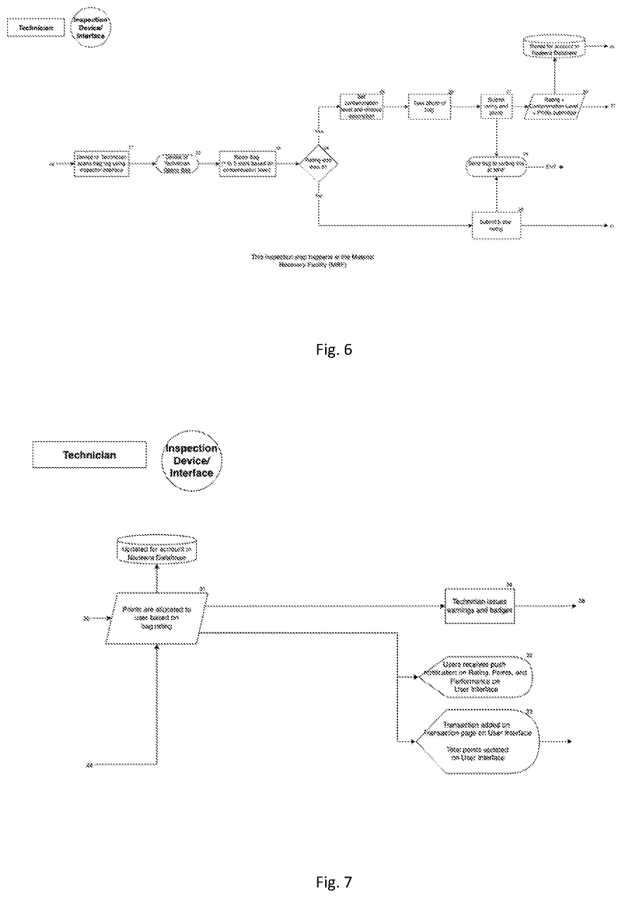

In case the tag is valid, the waste container is sent for preliminary inspection by the Technician. As shown in FIG. 6, the waste container is weighed by a scale 904 and opened so the contents are inspected, and a rating is given to each container based on the contamination level of the container and according to preset rating criteria.

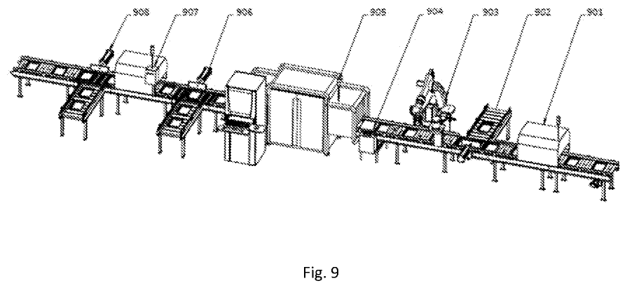

In another embodiment, the preliminary inspection is concluded automatically in an X-Ray chamber 905 as shown in FIG. 9.

In one embodiment, and in case a User had high ratings for a long period of time, some of the waste containers linked to said User may skip inspection.

In one embodiment, the waste container is opened and inspected manually by the Technician with the help of the Technician Handheld Interface.

In another embodiment, as shown in FIG. 9, the waste container is opened and inspected by an automated or semi-automated arm 903.

In one embodiment, the rating of the contents of the waste container is done manually by the Technician.

In another embodiment, the rating of the contents of the waste container is done automatically by an automated inspection unit 907, wherein said unit comprises a device, like camera, x-ray, infra-red, lidar or any other, that helps in recognizing the type of material said device that is aimed at the waste, the device is then used for collecting image information of the waste thrown into the waste collecting container; the waste classification recognition module present in the servers at HQ is used for analyzing the image information to obtain waste classification result information, hence the rating (FIG. 8).

In case the rating is at its highest score, said rating is automatically submitted to the HQ server and the waste container is sent to sorting on a separate belt, conveyor belt 906.

In case the rating is not at its highest score, the rating is submitted to the server in addition to a photo taken of the waste container's contents and the contamination level and type.

Irrespective of the rating, as shown in FIG. 6, the waste container is sent to sorting belt 908 where secondary sorting is performed.

In one embodiment, in case the rating and contamination level are conducted automatically, the Technician may override the results and submit their own ratings.

In one embodiment, the special waste containers are treated separately from the recyclables, residuals, and organic waste containers.

In the database, as shown in FIG. 7, each container rating, contamination level, and the photo submitted are saved under the assigned User account. Based on that, reward points are added or deducted from the User account.

As seen in FIG. 8, on the User Handheld Interface, the User will receive an update concerning the reward points, contamination level in the submitted waste containers and any warnings. The prompt shows the date of the operation, the type of waste, the container rating, as well as the points collected or deducted per each operation. Additionally, the User will receive details about any sorting violation committed along with recommendations and instructions for improvement in the sorting process.

Although the invention has been described with reference to specific examples, it will be appreciated by those skilled in the art that the invention may be embodied in many other forms. It should also be understood that the various aspects and embodiments of the invention as described can be implemented either independently, or in conjunction with all viable permutations and combinations of other aspects and embodiments. All such permutations and combinations should be regarded as having been herein disclosed.

1- A system for waste attribution comprising:
A plurality of labeled waste containers;
A server;
An initial sorting process;
A plurality of handheld devices;
An automated inspection device;
A collection process;
A collection point;
An inspection process;
A rating, feedback, and incentive process.

2- The system according to claim 1, wherein the plurality of identification tags may be a QR code or any equivalent carrying User's data and preplaced or placed on waste containers.

3- The system according to claim 1, wherein the plurality of identification tags may come in packages.

4- The system according to claim 1, wherein the initial sorting process is executed by individuals or equivalent.

5- The system according to claim 1, wherein one the plurality of the handheld devices is a User Handheld Interface device and comprises a camera used for collecting image information of the waste thrown into the waste containers.

6- The system according to claim 1, wherein the User Handheld device comprises an interface used to send to the User waste sorting information, rating, rewards, pickup schedules, or any necessary information.

7- The system according to claim 1, wherein the collection process is executed by individuals or equivalent.

8- The system according to claim 1, wherein one of the plurality of the handheld devices is a Collection Officer handheld device and comprises a camera used for scanning identification tags of the waste containers.

9- The system according to claim 1, wherein the Collection Officer handheld device comprises an interface used to send approvals concerning the waste container or any necessary information.

10- The system according to claim 1, wherein the rating process is executed by individuals or equivalents or a combination of thereof.

11- The system according to claim 1, wherein one of the plurality of the handheld devices is a Technician handheld device and comprises a camera used for collecting image information of the waste thrown into the waste containers.

12- The system according to claim 1, wherein the Technician handheld device comprises an interface to process the image taken by the device and specify a rating to each waste container.

13- A process for waste attribution comprising the steps of:
a. Admin creating User's account on a server wherein the said account comprises all information about one User;
b. Distributing tagged containers to Users;
c. Users scanning said identification tags using the User's Handheld Device and linking them to their account or having them pre-linked to their accounts;
d. Users sorting the waste into different waste containers;
e. Users using the tagged waste containers or placing the tag on the waste containers;
f. Users using the handheld device to make sure the sorting is done correctly to self-assess;
g. Collection vehicles follow a pickup schedule, collect the waste containers and transport them to the Material Recovery Facility;
h. At the collection point, the waste containers tags are scanned to make sure the tags are valid or if the linked User has high ratings, some waste containers may skip inspection;
i. The waste containers with valid tags and require inspection being sent for inspection;
j. A rating is given to each waste container according to a preset scoring criteria;
k. A feedback message is sent to Users describing all the mistakes during the sorting process and ways to improve the waste sorting process;
I. Reward or penalties are given or deducted from the accounts linked to the waste container tag.
